(19) United States
(12) Patent Application Publication
(10) Pub. No.: US 2019/0327944 A1
(43) Pub. Date: Oct. 31, 2019

(54) AQUATIC HABITAT STRUCTURE FOR UNDERWATER ORGANISMS

(71) Applicants: UWM Research Foundation, Inc., Milwaukee, WI (US); Harbor District, Inc., Milwaukee, WI (US)

(72) Inventors: Lindsay Frost, Milwaukee, WI (US); Geoffrey Anderson, Racine, WI (US)

(21) Appl. No.: 16/399,600

(22) Filed: Apr. 30, 2019

Related U.S. Application Data
(60) Provisional application No. 62/664,333, filed on Apr. 30, 2018.

(51) Int. Cl. A01K 61/78; A01G 33/00; A01G 24/42

(52) U.S. Cl. CPC A01K 61/78; A01G 24/42; A01G 33/00

(57) ABSTRACT

An aquatic habitat structure mountable with a bulkhead includes an elongate body including a longitudinal axis, and a mounting member configured to couple the elongate body to the bulkhead. The aquatic habitat structure additionally includes one or more modular habitats, and one or more mounting brackets, wherein each of the one or more mounting brackets are configured to couple at least one of the one or more modular habitats to the elongate body.

### CROSS-REFERENCE TO RELATED APPLICATIONS

This application claims priority to U.S. Provisional Patent Application No. 62/664,333, filed Apr. 30, 2018, the contents of which are incorporated herein by reference.

### FIELD OF THE INVENTION

Embodiments described herein relate to a structure for underwater organisms, and more particularly to an aquatic habitat structure including modular habitat features for underwater organisms.

### SUMMARY

During the development of urbanized and industrial waterways, the habitation of various underwater organisms may be damaged or eradicated.

At least some embodiments described herein allow for the development of artificial habitat development of underwater organisms in a compact area, thereby preventing harm and endangerment to the underwater organisms, while still allowing for urban development.

In one aspect, an aquatic habitat structure mountable with a bulkhead includes an elongate body including a longitudinal axis, a mounting member configured to couple the elongate body to the bulkhead, one or more modular habitats, and one or more mounting brackets, wherein each of the one or more mounting brackets are configured to couple at least one of the one or more modular habitats to the elongate body.

In another aspect, an aquatic habitat structure mountable with a bulkhead includes a frame member configured to be mountable with the bulkhead, and one or more modular habitats coupled to the frame member, wherein each of the one or more modular habitat includes a container having associated therewith one or more of a planting medium, a gravel-like medium, vegetation and a vegetation mimic.

In another aspect, an aquatic habitat structure mountable with a bulkhead includes a frame member configured to be mountable with the bulkhead, one or more modular habitats, and one or more fastening assemblies, each configured to couple at least one of the modular habitats to the frame member.

Other aspects of the disclosure will become apparent by consideration of the detailed description and accompanying drawings.

### BRIEF DESCRIPTION OF THE DRAWINGS

FIG. 1 is an aquatic habitat structure including a plurality of modular habitats for underwater organisms.

FIG. 2A is a side view of a frame member of the aquatic habitat structure of FIG. 1 mounted to a bulkhead at a first position.

FIG. 2B is another side view of the frame member of the aquatic habitat structure of FIG. 1 mounted to a bulkhead at a second position.

FIG. 2C is another side view of the frame member of the aquatic habitat structure of FIG. 1 mounted to a bulkhead at a third position.

FIG. 3A is an enlarged perspective view of the frame member of the aquatic habitat structure of FIG. 1, including a mounting member.

FIG. 3B is an enlarged perspective view of the frame member of the aquatic habitat structure of FIG. 1, including an alternative mounting member.

FIG. 4 is a perspective view of the aquatic habitat structure of FIG. 1, with the bulkhead removed.

FIG. 5 is an enlarged side view of the aquatic habitat structure of FIG. 4.

FIG. 6 is another enlarged side view of the aquatic habitat structure of FIG. 4.

FIG. 7 is another enlarged side view of the aquatic habitat structure of FIG. 4.

FIG. 8 is a perspective view of an alternative aquatic habitat structure including a plurality of modular habitats for underwater organisms.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Terms of degree, such as “substantially” or “approximately” are understood by those of ordinary skill to refer to reasonable ranges outside of the given value, for example, general tolerances associated with manufacturing, assembly, and use of the described embodiments. For example, “substantially” can be defined as being within about 5 percent to about 10 percent of a given value.

Illustrated herein are various embodiments of an aquatic habitat structure that provides an artificial habitat for underwater organisms. The aquatic habitat structure may be coupled to a bulkhead (e.g., a dock wall, steel sheet piling, a hardened shoreline, a river wall, etc.) and is capable of being partially or fully submerged. The aquatic habitat structure includes a plurality of modular habitats providing diverse habitat types for fish, aquatic invertebrates, and other aquatic organisms in various waterways and bodies of water. This structure is beneficial in areas of urbanized and/or industrial waterways, in which aquatic habitats are limited.

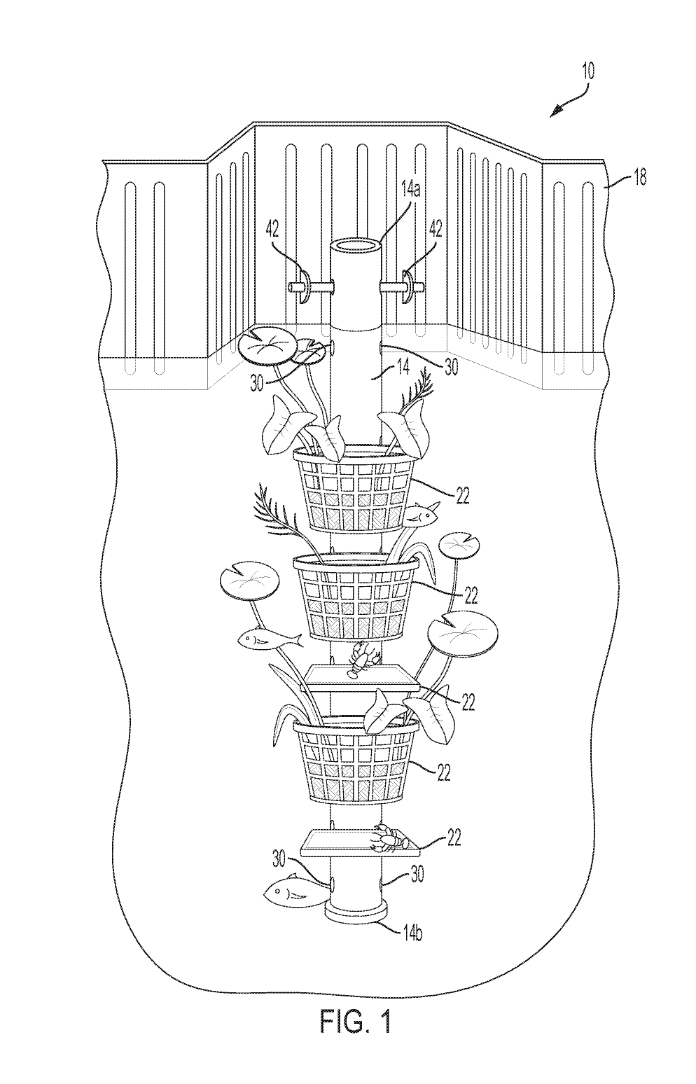

FIG. 1 illustrates an aquatic habitat structure 10. The aquatic habitat structure includes a frame member 14 mountable with a bulkhead 18 and configured to be submerged in a body of water. The bulkhead 18 may be a dock wall, a steel sheet piling, a hardened shoreline, a river wall, or any alternative surface within a body of water. The aquatic habitat structure 10 additionally includes several modular habitats 22 removably coupled to the frame member 14.

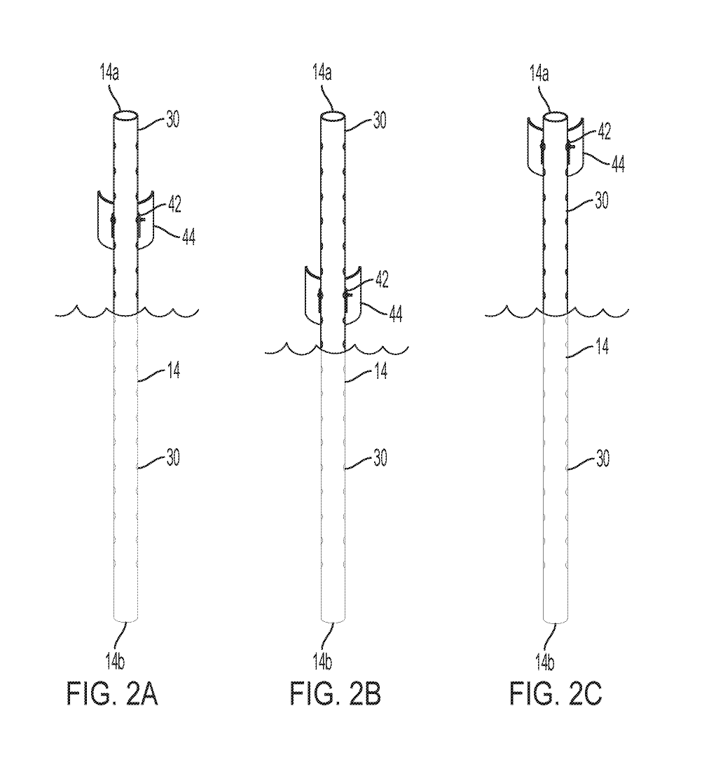

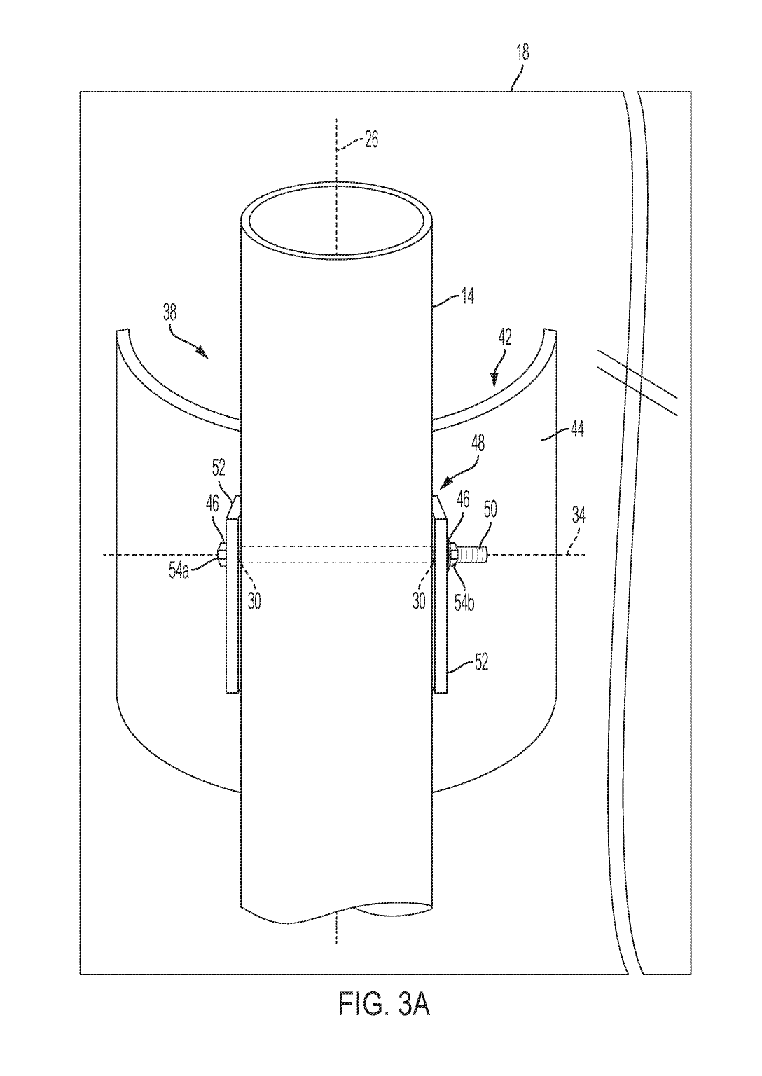

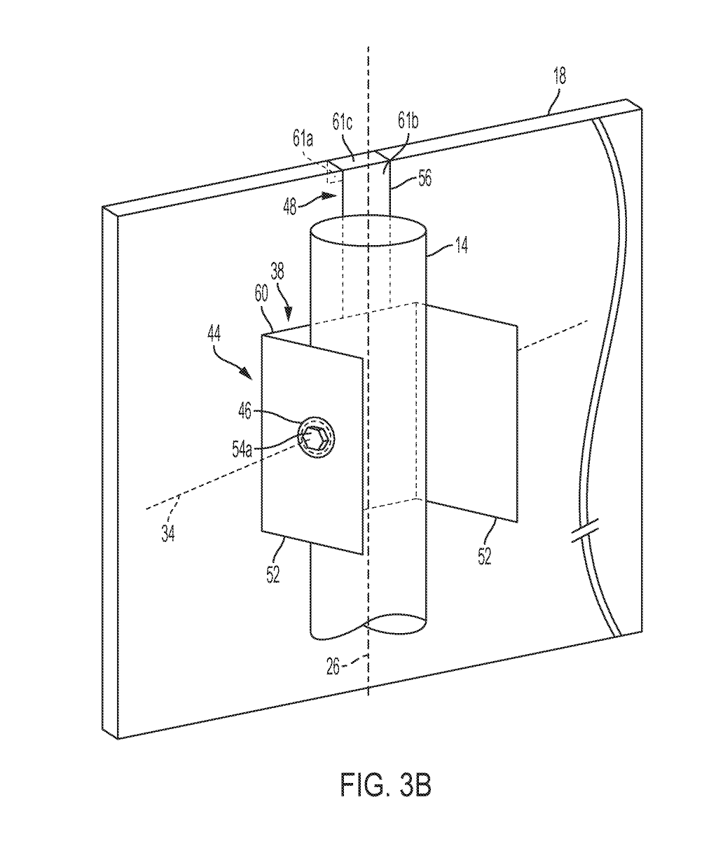

With references to FIGS. 1-3B, the frame member 14 is a substantially tubular elongate body 14 including a first, top end 14a and a second, bottom end 14b opposite the top end 14a. The elongate body 14 further includes a longitudinal axis 26 (FIGS. 3A and 3B) that extends through the first end 14a and the second end 14b. In some embodiments, the height of the elongate body 14 from the first end 14a to the second end 14b is within a range of 5 feet to 20 feet. In the shown embodiments, the elongate body 14 is composed of a metallic material (e.g., steel, aluminum). However, in alternative embodiments, the elongate body 14 may be composed of non-metallic materials (e.g., composite materials, etc.). While illustrated as having a tubular shape that is cylindrical (i.e., having a circular cross-section), in some embodiments, the tubular shape is rectangular, square, or another geometric shape (i.e., with a rectangular cross-section, square cross-section, or another geometric shaped cross-section, respectively). The elongate body 14 includes various apertures 30 positioned along the body 14. More specifically, each aperture 30 extends through the body 14 along a first axis 34 (FIGS. 3A and 3B), which is substantially normal to the longitudinal axis 26. Specifically, the body 14 illustrated in FIGS. 2A-2C includes eighteen apertures 30 spaced approximately 12 inches apart. However, in alternative embodiments, the body 14 may include fewer or more apertures 30 spaced at alternative distances. Additionally, in alternative embodiments, the apertures 30 may extend through only one side of the body 14.

With reference to FIGS. 2A-2C, the elongate body 14 is adjustable relative to the bulkhead 18 along the longitudinal axis 26 to accommodate seasonal and/or water level changes. More specifically, a mounting assembly 38 (FIGS. 3A and 3B) is engageable with the apertures 30 in order to removably couple the body 14 to the bulkhead 18.

With reference to FIG. 3A, the mounting assembly 38 includes a mounting member 42 and a pin 50. The mounting member 42 includes a first portion 44, which is a substantially c-shaped (e.g., semi-circular) plate or bracket, and a second portion 48. The second portion 48 includes two substantially flat, similarly sized plates 52 extending parallel to each other. Specifically, the second portion 48 is welded to the first portion 44. However, in alternative embodiments, the first and second portions 44, 48 may be one, uniform piece. In alternative embodiments, the mounting member 42 may include alternative shapes. For example, with reference to FIG. 3B, the first portion 44 of the mounting member 42 may include a bracket 56 configured to engage the bulkhead 18. In such instances, the second portion 48 includes a wall 60 extending between the first and second plates 52, and the bracket 56 extending from the wall 60, and the body 14 couples to the first and second plates 52 similar to the embodiment of FIG. 3A (e.g., with the pin 50 passing through respective apertures in the body 14 and plates 52). The bracket 56 of the mounting member 42 may be positioned on an upper edge of the bulkhead 18, thereby allowing the mounting member 42 to hang on the bulkhead 18. As illustrated, the bracket 56 includes two substantially parallel plates 61a,b that extend vertically from an intermediate horizontal plate 61c. The bracket 56 is hung from the bulkhead 18 such that the bulkhead 18 is positioned between the two substantially parallel plates 61a,b, and the horizontal plate 61c rests on the top of the bulkhead 18. In some embodiments, the bracket 56 is one or more of friction fit, welded, adhered, or fastened to the bulkhead 18. In some embodiments, the bracket 56 hangs from a projection or receptacle of the bulkhead 18 that is configured to mate with the bracket 56.

With reference to FIG. 3A, the first portion 44 of the mounting member 42 is permanently coupled to the bulkhead 18 via a welded connection. However, in alternative embodiments, the mounting member 42 may be removably coupled to the bulkhead 18, or permanently fastened to the bulkhead 18 via alternative connection methods (e.g., threaded fasteners, adhesives, etc.). The second portion 48 of the mounting member 42 include openings, or apertures, 46 extending through the plates 52. In some embodiments, the openings 46 are additionally similarly sized to the apertures 30 on the body 14.

During installation and/or adjustment of the body 14 relative to the bulkhead 18, the body 14 may be positioned between the plates 52 of the second portion 48 of the mounting member 42. More specifically, the openings 46 may be aligned with one of the apertures 30. As shown in FIG. 3A, a pin 50 is insertable through the mounting member openings 46, and the aperture 30, thereby coupling the body 14 to the bulkhead 18. In the illustrated embodiments, the pin 50 is a threaded bolt with a head 54a on a first end and a nut 54b threaded on a second end, thereby preventing the pin 50 from disengaging the mounting member openings 46 and/or the aperture 30. In alternative embodiments, alternative fasteners (e.g., a hinge pin, a pin with a retaining clip, and the like) may be used instead of the pin 50. To adjust the position of the body 14 relative to the bulkhead 18, the pin 50 may be removed from the openings 46 and the aperture 30, thereby allowing a user to slide the body 14 along the longitudinal axis 26 relative to the mounting member 42. The user may then align another of the apertures 30 (at a different vertical position along the longitudinal axis 26) with the openings 46, and couple the body 14 to the bulkhead 14 via the pin 50. In alternative embodiments, the aquatic habitat structure 10 may include alternative fastening methods to couple the body 14 to the bulkhead 18.

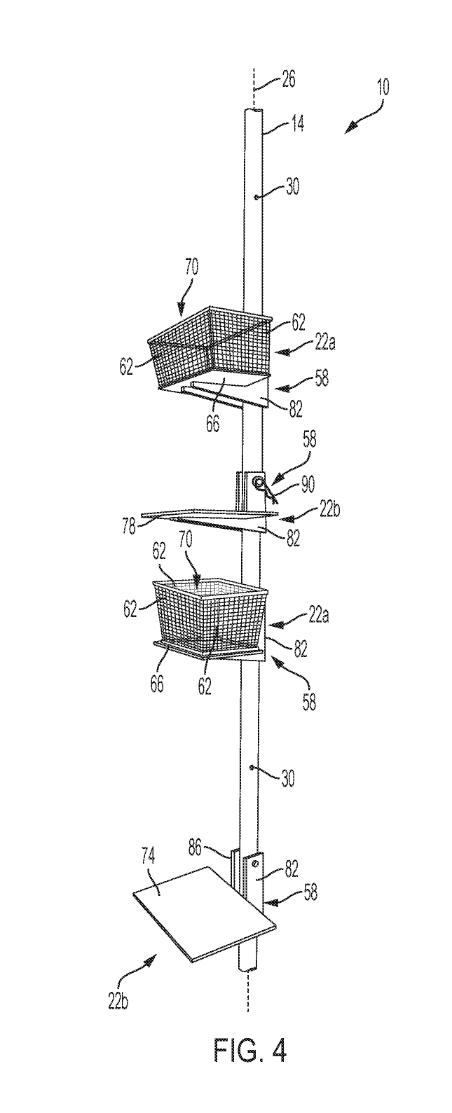

As illustrated in FIG. 4, various modular habitats 22 are removably coupled to the body 14. The modular habitats may include containers, baskets, boxes, platforms, fish caves, plants, etc. that provide habitat features, shelter, cover, foraging, plant growth, algal growth, invertebrate colonization, and additional benefits to fish and aquatic organisms. As shown in FIGS. 4-7, the modular habitats 22 are removably coupled to the body 14 via a fastening assembly 58 positioned between the body 14 and each of the modular habitats 22. More specifically, the fastening assembly 58 couples each of the modular habitats 22 to one of the apertures 30, thereby vertically aligning the modular habitats 22 along an axis substantially parallel to the longitudinal axis 26. In FIG. 4, the aquatic habitat structure 10 includes four modular habitats 22. However, in alternative embodiments, the aquatic habitat structure 10 includes fewer or more modular habitats 22.

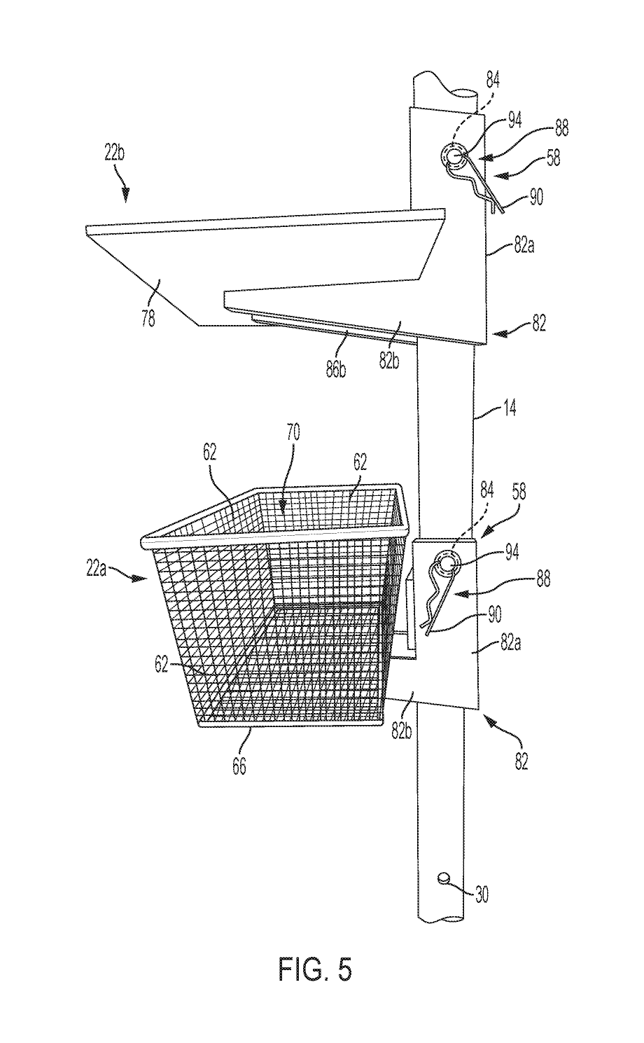

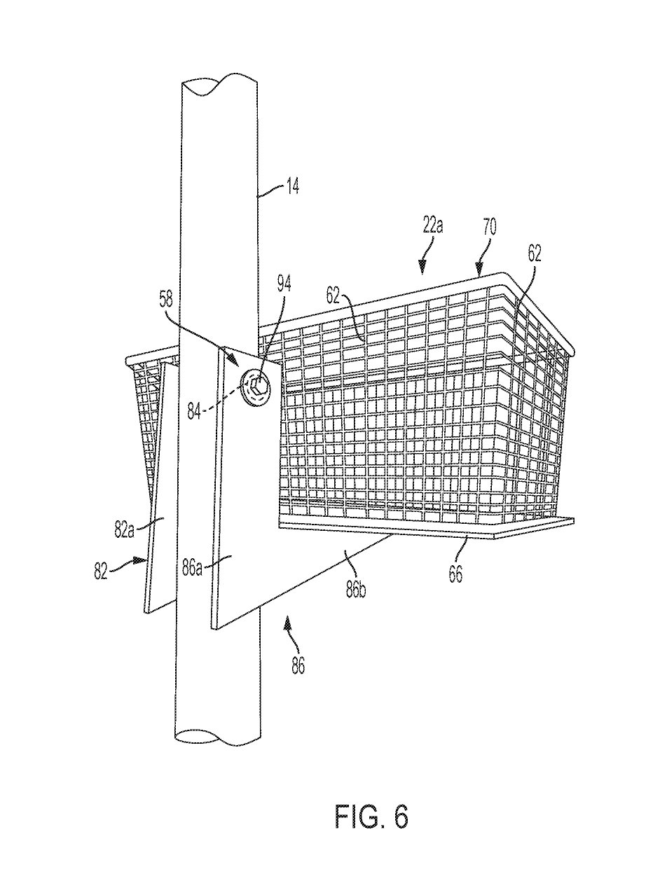

FIGS. 5-6 illustrate two of the modular habitats 22 as a modular container and/or basket 22a. The modular container 22a includes four flat sidewalls 62 and a bottom wall 66 that define a generally rectangular cuboid volume. In the illustrated embodiments, the walls 62, 66 are composed of a mesh, wireframe material. However, in alternative embodiments, the walls 62, 66 are composed of alternative, solid materials capable of being submerged in water (e.g., metals, composites, etc.). The container 22a additionally includes an opening 70, thereby providing additional access to the defined volume. The bottom wall 66 is optionally filled with soil, gravel-like medium, plant bulbs, planting mediums, vegetation, vegetation mimic, etc. In some embodiments, the modular container 22a may be lined with landscaping fabric to retain soil and/or other materials. The fastening assembly 58 is coupled to an outer surface of the bottom wall 66 of the modular container 22a, thereby coupling the modular container 22a to the elongate body 14. In some embodiments, an edge or one of the sidewalls 62 of the container 22a may be secured to the fastening assembly 58. In some embodiments, a container is provided as a modular habitat 22 that includes fewer or more than four sidewalls that define a volume having another non-rectangular cuboid shape.

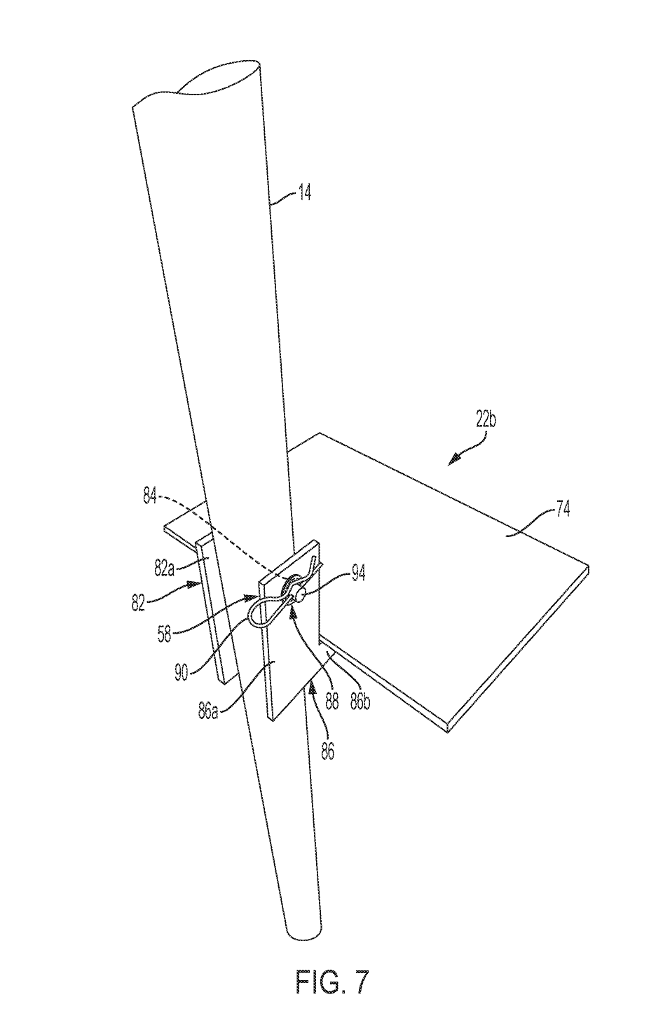

FIG. 7 illustrates the modular habitat 22 as a modular platform and/or shelving unit 22b. In such embodiments, the modular platform 22b is generally rectangular and includes a top planar surface 74 and a bottom planar surface 78 for supporting various organisms. For example, the modular platform 22b may provide shade and/or cover for small fish, or serve as an outcropping for crayfish and other benthic organisms. The modular platform 22b in the shown embodiments is composed of stainless steel. However, in alternative embodiments, the modular platform 22b may be composed of alternative materials (e.g., other metals or composites). In the shown embodiments, the fastening assembly 58 is coupled to the bottom planar surface 78 of the modular platform 22b, thereby coupling the modular platform 22b to the elongate body 14. In some embodiments, a sidewall or edge of the modular platform 22b may be secured to the fastening assembly.

In some embodiments, the modular habitat 22 may be vegetation, plants, faux-vegetation, and/or vegetation mimics. The vegetation may be positioned directly on the frame member 14 as a standalone modular habitat, or may alternatively be positioned within one of the additional modular habitats 22 (e.g., within the modular container 22a). Specifically, the aquatic habitat structure 10 may accommodate any type of plant capable of surviving in the habitat's location and/or underwater. Examples of plants compatible with the aquatic habitat structure 10 may include, but are not limited to, water lilies, pickerel weed, sago pondweed, water celery, etc.

The shown embodiments illustrate the aquatic habitat structure 10 including two modular containers 22a and two modular platforms 22b. However, in some embodiments, the aquatic habitat structure 10 may include alternative combinations of modular habitats 22. For example, the aquatic habitat structure 10 may include fewer or more modular containers 22a , fewer or more modular platforms 22b, and/or additional types of modular habitats not described herein. In some embodiments, the modular habitats 22 may additionally or alternatively include features which mimic naturally-occurring habitats used by aquatic organisms. This includes, but is not limited to, rock outcroppings, gravel beds, sand beds, lean-to structures, sculptures, wood debris, etc.

With reference to FIGS. 5-7, the fastening assembly 58 includes a first mounting bracket 82, a second mounting bracket 86, and a connector 88 including a retainer 90 and a fastener 94. The first and second mounting brackets 82, 86 are flat, identically sized plates extending parallel to each other. More specifically, the mounting brackets 82, 86 are substantially L-shaped such that a first portion 82a, 86a of the brackets 82, 86 extends along the body 14 in a direction substantially parallel to the longitudinal axis 26, and a second portion 82b, 86b of the brackets 82, 86 extends away from the body 14 in a direction substantially normal to the longitudinal axis 26. The second portion 82b, 86b of the brackets 82, 86 is coupled to the outer surface of the bottom wall 66 of one of the modular habitats 22 (or the bottom planar surface 78 of the modular platform 22b). In the shown embodiments, the modular habitat 22 is welded to the second portion 82b, 86b of the brackets 82, 86. However, in alternative embodiments, the modular habitat 22 may be coupled to the brackets 82, 86 via alternative fastening methods (e.g., threaded fasteners, adhesives).

The first and second modular brackets 82, 86 each include an opening, or aperture, 84 extending through the brackets 82, 86. When the brackets 82, 86 are positioned against the body 14, the openings 84 are aligned along the first axis 34. Furthermore, in some embodiments, the openings 84 are similarly sized to the apertures 30 of the body 14. During installation of one of the modular units 22 to the body 14, the first and second brackets 82, 86 are positioned on opposite sides of the main body 14 and the bracket openings 84 are aligned with one of the apertures 30. With continued reference to FIGS. 5-7, the fastener 94 is insertable through the first bracket opening 84, one of the apertures 20, and the second bracket opening 84, and the retainer 90 engages the fastener 94, thereby coupling the modular habitat 22 to the body 14. In the illustrated embodiment, the fastener 94 is a clevis pin and the retainer 90 is a snap pin. However, in alternative embodiments, alternative types of fasteners and/or connectors (e.g., a bolt and nut, a hinge pin, etc.) used as the connector 88 to secure the modular unit 22 to the body 14. To remove or reposition the modular unit 22 relative to the body 14, the retainer 90 and fastener 94 may be removed, thereby allowing the user to slide the modular unit 22 (and fastening assembly 58) away from the body 14. In alternative embodiments, the fastening assembly 58 may be permanently connected to the body 14, and the modular unit 22 may be removable independent of the fastening assembly 58. In still further embodiments, the fastening assembly 58 and modular unit 22 may both be permanently connected to the main body 14.

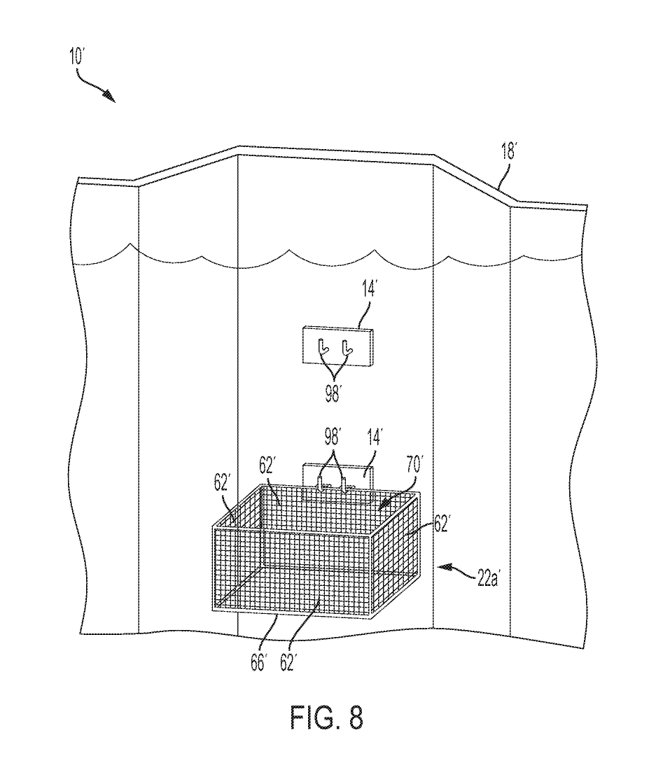

FIG. 8 illustrates an alternative embodiment of the aquatic habitat structure 10′. The illustrated aquatic habitat structure 10′ is similar to the aquatic habitat structure 10 described above with respect to FIGS. 1-7 and includes like parts, and, accordingly, the below description of the aquatic habitat structure 10′ focuses on the differences with respect to the aquatic habitat structure 10. Reference is hereby made to the description of the aquatic habitat structure 10 shown in FIGS. 1-7 for description of features and elements of the aquatic habitat structure 10′ not specifically included below.

The illustrated aquatic habitat structure 10′ includes frame members 14′, bulkhead 18′, and a modular habitat 22′. Each frame member 14′ is a rectangular plate coupled to the bulkhead 18′. In some embodiments, the frame members 14′ are removably coupled (e.g., via fasteners) to the bulkhead 18′. In other embodiments, the frame members 14′ are permanently coupled (e.g., via welding) or integrally formed with the bulkhead 18′ when the bulkhead 18′ is formed or cast. The frame member 14′ additionally includes at least one substantially L-shaped flange 98′ protruding from the frame member 14′ for engaging the modular habitat 22′. In the illustrated embodiment, the frame member 14′ includes two flanges 98′. However, in alternative embodiments, the frame member 14′ may include fewer or more flanges 98′. Specifically, an edge of the modular habitat 22′ is positioned in a corner of L-shaped flange 98′, thereby preventing the modular habitat 22′ from disengaging the frame member 14′. A user may remove or reposition the modular unit 22′ from the frame member 14′ by grasping the modular habitat 22′ and pulling in an upwards direction, thereby disengaging the edge of the modular habitat 22′ from the flange 98′. In the shown embodiments, the modular habitat 22′ is a modular container 22a′. However, in alternative embodiments, the modular habitat 22′ is an alternative habitat structure, such as described above (e.g., modular platform). In still further embodiments, the modular habitat 22′ may include a protrusion or hook for engaging the flange 98′ of the frame member 14′.

Although the disclosure has been described in detail with reference to certain embodiments, variations and modifications exist within the scope and spirit of one or more independent aspects of the disclosure as described. Various features and advantages of the disclosure are set forth in the following claims.

What is claimed is:

1. An aquatic habitat structure mountable with a bulkhead, the structure comprising:
an elongate body including a longitudinal axis;
a mounting member configured to couple the elongate body to the bulkhead;
one or more modular habitats; and
one or more mounting brackets, wherein each of the one or more mounting brackets are configured to couple at least one of the one or more modular habitats to the elongate body.

2. The structure of claim 1, wherein the elongate body includes a plurality of apertures.

3. The structure of claim 2, wherein each of the one or more mounting brackets includes a mounting bracket positioned between the elongate body and one of the one or more modular habitats, and a connector engageable with the mounting bracket and one of the plurality of apertures to couple of the modular habitats to the elongate body.

4. The structure of claim 1, wherein each of the one or more modular habitat includes a container having associated therewith one or more of a planting medium, a gravel-like medium, vegetation, and a vegetation mimic.

5. An aquatic habitat structure mountable with a bulkhead, the structure comprising:
a frame member configured to be mountable with the bulkhead; and
one or more modular habitats coupled to the frame member;
wherein each of the one or more modular habitats includes a container having associated therewith one or more of a planting medium, a gravel-like medium, vegetation and a vegetation mimic.

6. The structure of claim 5, wherein the frame member is moveable relative to the bulkhead along a longitudinal axis of the frame member.

7. The structure of claim 5, wherein the frame member is removably coupled to the bulkhead.

8. The structure of claim 5, wherein each of the one or more modular habitats are removably coupled to the frame member.

9. The structure of claim 8, wherein each of the one or more modular habitats are removably coupled to the frame member by a fastening assembly.

10. The structure of claim 5, wherein the container is a basket having at least one mesh sidewall.

11. The structure of claim 5, wherein the container includes a flat horizontal surface.

12. The structure of claim 5, wherein the frame member includes a plurality of apertures, and wherein each of the one or more modular habitats are removably coupled to one of the plurality of apertures by a mounting bracket.

13. The structure of claim 5, wherein the frame member includes an elongate body having a longitudinal axis and a plurality of apertures arranged along the longitudinal axis.

14. An aquatic habitat structure mountable with a bulkhead, the structure comprising:
a frame member configured to be mountable with the bulkhead;
one or more modular habitats; and
one or more fastening assemblies, each configured to couple at least one of the modular habitats to the frame member.

15. The structure of claim 14, wherein the frame member includes an elongate body.

16. The structure of claim 14, wherein the frame member is moveable relative to the bulkhead.

17. The structure of claim 14, wherein the frame member is vertically adjustable relative to the bulkhead along a longitudinal axis of the frame member.

18. The structure of claim 14, wherein the frame member includes a plurality of apertures.

19. The structure of claim 18, further comprising a first mounting member configured to removably couple the frame member to the bulkhead via one of the plurality of apertures.

20. The structure of claim 19, wherein each of the one or more fastening assemblies include
one or more mounting brackets, wherein each of the one or more mounting brackets are positioned between the frame member and one of the one or more modular habitats; and
one or more connectors, wherein each of the one or more connectors are engagable with one of the one or more mounting brackets and one of the plurality of apertures to removably couple one of the one or more modular habitats to the frame member.
